(19) United States
(12) Patent Application Publication
(10) Pub. No.: US 2014/0099089 A1
(43) Pub. Date: Apr. 10, 2014

(54) OPTICAL APPARATUS AND IMAGE PICKUP APPARATUS HAVING THE SAME

(71) Applicant: Canon Kabushiki Kaisha, Tokyo (JP)

(72) Inventors: Kenichi Katano, Kawasaki-shi (JP); Yosuke Fukai, Kawasaki-shi (JP); Keisuke Adachi, Kawasaki-shi (JP)

(73) Assignee: Canon Kabushiki Kaisha, Tokyo (JP)

(21) Appl. No.: 14/044,180

(22) Filed: Oct. 2, 2013

(30) Foreign Application Priority Data
Oct. 4, 2012 (JP) 2012-221998

(51) Int. Cl. G03B 9/06; G02B 27/64

(52) U.S. Cl. CPC G03B 9/06; G02B 27/646
USPC 396/55; 396/510

(57) ABSTRACT

An optical apparatus includes a first optical member (10) on which a concave curved surface is formed, a second optical member (20) on which a convex curved surface is formed, and a light amount adjuster (23) that includes a plurality of blade members (233) each having a convex curved shape portion and that changes size of an aperture to pass a light beam by a rotation of the blade members (233), the first and second optical members are disposed side by side in an optical axis direction so that the concave curved surfaces of the first and second optical members face each other, the light amount adjuster is disposed between the first and second optical members, and a radius of curvature of the convex curved shape portion of the blade member is smaller than that of the first optical member and is larger than that of the second optical member.

### BACKGROUND OF THE INVENTION

1. Field of the Invention

The present invention relates to an optical apparatus and an image pickup apparatus having the optical apparatus, and more particularly to a light amount adjusting mechanism and an image stabilizing mechanism of the optical apparatus.

2. Description of the Related Art

Japanese Patent Laid-open No. 2007-94074 discloses a light amount adjusting apparatus in which a blade member having a curved shape approximated to a lens curved surface is disposed between a first lens and a second lens in a state where a part of the second lens having a convex shape is inserted into a part of the first lens having a concave shape when a lens barrel is retracted. In Japanese Patent Laid-open No. 2007-94074, even when the light amount adjusting apparatus is disposed between the first lens and the second lens, reducing the thickness in an optical axis direction may be achieved since the first lens and the second lens come closer to each other to a point where a part of the second lens inserted into a part of the first lens when the lens barrel is retracted.

Generally, in order to hold a lens in a lens frame in a fixed manner, a resin thermal caulking which fixes a part of the lens frame by heat welding, adhesion by an adhesive agent, or the like is applied. When the resin thermal caulking is applied, it is required that rib-shaped convex protrusions to be protruded from the lens frame be formed around the lens. When the adhesion is applied, it is required that rib-shaped convex protrusions be formed around the lens so as to secure space for pooling adhesive agent.

Accordingly, when the first lens and the second lens of Japanese Patent Laid-open No. 2007-94074 are held in the lens frame in a fixed manner by the thermal caulking or the adhesion, rib-shaped convex protrusions are formed around the first lens and the second lens, respectively. The formed convex protrusions are protruded from an extended line of a curved surface of a concave portion in the first lens to a blade side, and from an extended line of a curved surface of a convex portion in the second lens to the blade side. Accordingly, when the curvatures of the first lens, the blade, and the second lens are set substantially to the same value, a risk occurs where the convex protrusions are interfered by, or in other words collide with, the blade, at a retracted state in which the first lens, the blade, and the second lens come close to each other. Thus, there is a problem that distances in the optical direction between the first lens and the blade, and between the blade and the second lens should respectively be secured to some extent, at the retracted state. Longer distance in the optical direction between the first lens and the blade, and between the blade and the second lens makes the thickness in the optical direction increased, whereby an optical apparatus is enlarged.

### BRIEF SUMMARY OF THE INVENTION

The present invention provides an optical apparatus and an image pickup apparatus having the optical apparatus capable of reducing a thickness in an optical axis direction.

An optical apparatus as one aspect of the present invention includes a first optical member on which a concave curved surface is formed, a second optical member on which a convex curved surface is formed, and a light amount adjuster which includes a plurality of blade members each having a convex curved shape portion, configured to change a size of an aperture to pass a light beam by a rotation of the blade members, the first optical member and the second optical member are disposed side by side in an optical axis direction so that the concave curved surface of the first optical member and the convex curved surface of the second optical member face each other, the light amount adjuster is disposed between the first optical member and the second optical member, and a radius of curvature of the convex curved shape portion of the blade member is smaller than a radius of curvature of the concave curved surface of the first optical member and is larger than a radius of curvature of the convex curved surface of the second optical member.

An image pickup apparatus as another aspect of the present invention includes a first optical member on which a concave curved surface is formed, a second optical member on which a convex curved surface is formed, and a light amount adjuster which includes a plurality of blade members each having a convex curved shape portion, configured to change a size of an aperture to pass a light beam by a rotation of the blade members, the light amount adjuster is disposed between the first optical member and the second optical member, and a radius of curvature of the convex curved shape portion of the blade member is smaller than a radius of curvature of the concave curved surface of the first optical member and is larger than a radius of curvature of the convex curved surface of the second optical member.

### BRIEF DESCRIPTION OF THE DRAWINGS

FIG. 1 is a cross-sectional view of a lens barrel of an optical apparatus to which an embodiment of the present invention is applied, at the time of taking an image (in a wide-angle state).

FIG. 2 is a cross-sectional view of the lens barrel of the optical apparatus to which the embodiment of the present invention is applied, at the time of taking an image (in a telephoto state).

FIG. 3 is a cross-sectional view of the lens barrel of the optical apparatus to which the embodiment of the present invention is applied, when the lens barrel is retracted.

FIG. 4 is an exploded perspective view of the lens barrel of the optical apparatus to which the embodiment of the present invention is applied.

FIG. 5 is a perspective view of the optical apparatus to which the embodiment of the present invention is applied.

FIG. 6 is an exploded perspective view of a second unit to which the embodiment of the present invention is applied (Embodiment 1).

FIG. 7 is an exploded perspective view of an aperture apparatus to which the embodiment of the present invention is applied.

FIG. 8 is a cross-sectional view of the second unit to which the embodiment of the present invention is applied.

FIG. 9 is an expanded cross-sectional view of part A illustrated in FIG. 1.

FIG. 10 is an expanded cross-sectional view of part B illustrated in FIG. 2.

FIG. 11 is an exploded perspective view of another second unit to which the embodiment of the present invention is applied (Embodiment 2).

FIG. 12 is a detailed enlarged cross-sectional view of a positional relationship between the aperture apparatus of the second unit and a second unit holder of the optical apparatus to which the embodiment of the present invention is applied.

FIG. 13 is a front transparent view in which the second unit of the optical apparatus to which the embodiment of the present invention is applied is viewed from a front side.

### DETAILED DESCRIPTION OF THE EMBODIMENTS

Exemplary embodiments of the present invention will be described below with reference to the accompanied drawings.

### Embodiment 1

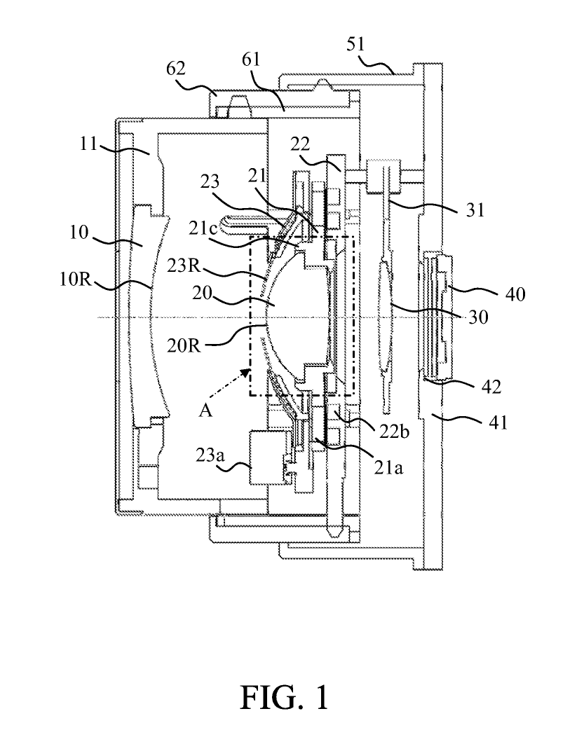

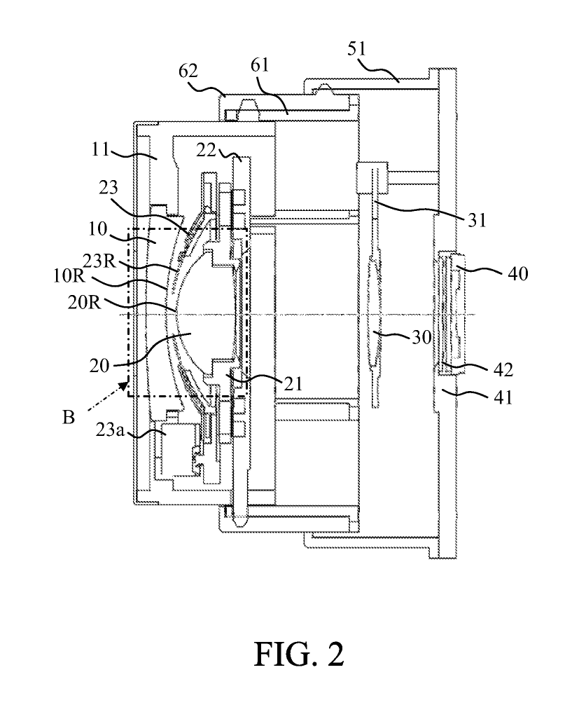

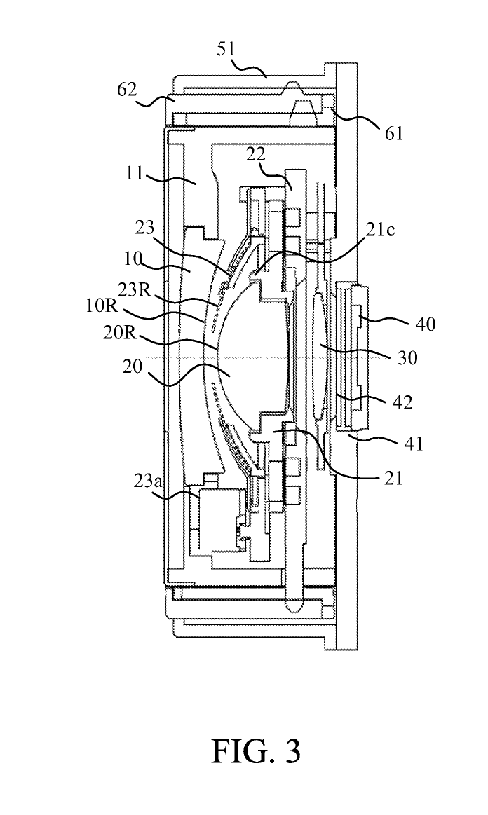

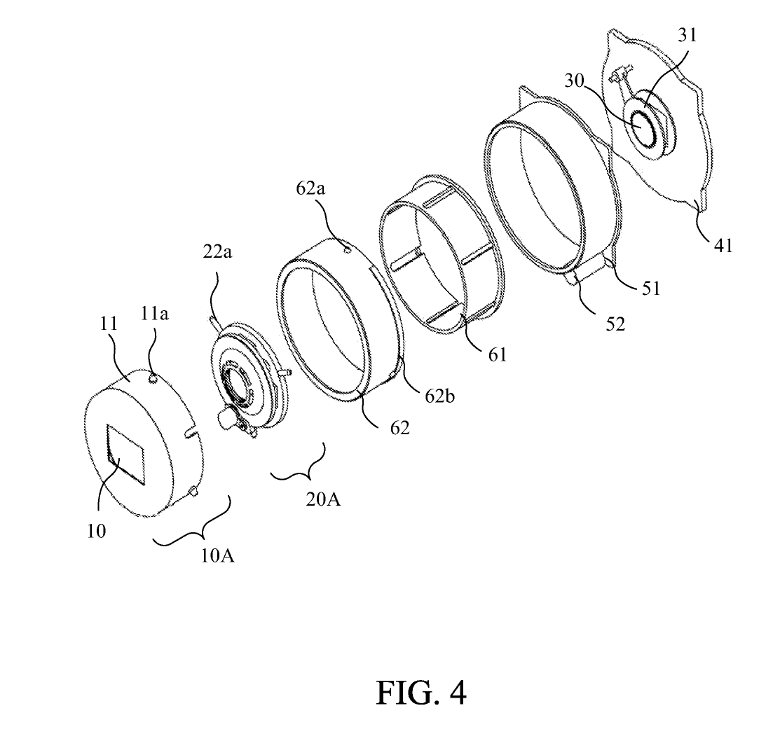

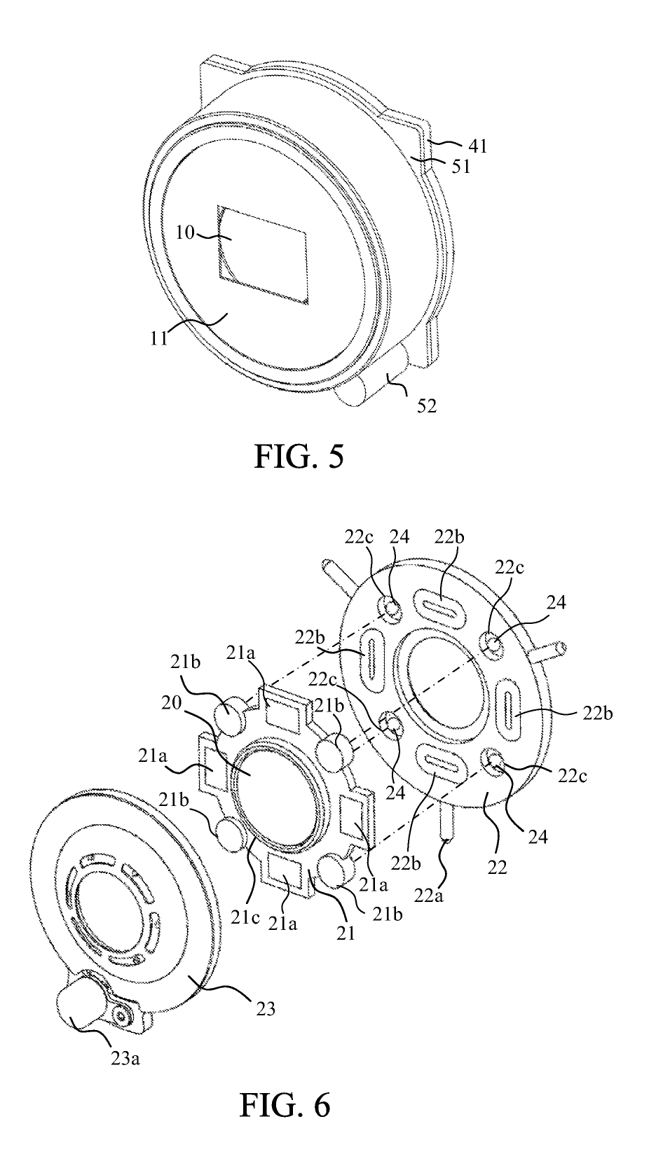

FIGS. 1 and 2 are respectively a cross-sectional view of a lens barrel (an optical apparatus) provided in an image pickup apparatus such as a compact digital camera, a single-lens reflex camera, a video camera, or the like, to which the present embodiment is applied, at the time of taking an image. In the present embodiment, a lens-integrated image pickup apparatus is described as an example, but the present invention is not limited to this and can also be applied to a lens-interchangeable image pickup apparatus, or a so-called interchangeable lens in an interchangeable lens system. FIG. 1 is a cross-sectional view of the lens barrel which is in a wide-angle state, and FIG. 2 is a cross-sectional view of the lens barrel which is in a telephoto state. As illustrated in FIG. 2, when the lens barrel is in the telephoto state, the distance between a lens 10 at the most-object side and a lens 20 adjacent to the lens 10 may be made as short as possible, whereby the lens barrel can be reduced in size and can have higher magnification. Further, FIG. 3 is a cross-sectional view of the lens barrel when the lens barrel is retracted. FIG. 4 is an exploded perspective view of the lens barrel of the optical apparatus to which the present embodiment is applied, and FIG. 5 is a perspective view of an example of the optical apparatus to which the present embodiment is applied.

As illustrated in FIGS. 1 to 3, the lens barrel of the present embodiment is configured by including three image-pickup lens units. A first lens unit 10 is held by a first unit barrel 11, a second lens unit 20 is held by a second unit holder 21, and the third lens unit 30 is held by a third unit holder 31. Further, the second lens unit 20 and the third lens unit 30 are supplied with power by a not-shown focus motor, and are configured so as to be movable in an optical axis direction. An image pickup element 40 is held by a sensor holder 41 along with a filter 42. In the present embodiment, as illustrated especially in FIGS. 2 and 3, a part of the second lens unit 20 having a convex shape is inserted (or sunk) into a part of the first lens unit 10 having a concave shape when the lens barrel is in the telephoto state and in the retracted state. That is to say, a part of the first lens unit 10 and a part of the second lens unit 20 overlap with each other in a direction orthogonal to the optical axis direction. Further, in the state where a part of the second lens unit 20 is inserted into a part of the first lens unit 10, an aperture unit 23 having a curved shape approximated to a lens curved surface is disposed between the first lens unit 10 and the second lens unit 20. In such a configuration, the optical apparatus of the present embodiment achieves reduction of the thickness in the optical axis direction.

The lens barrel of the present embodiment has a two-stage configuration, and is capable of changing the entire length of the lens barrel when taking an image and when being retracted. However, the lens barrel of the present invention is not limited to the two-stage configuration, and may take configurations of three or more stages.

Here, the configuration of the lens barrel in the present embodiment is described in detail.

As illustrated in FIGS. 1 to 4, a fixed barrel 51 holds a gear 52. The gear 52 meshes with a gear 62b of a cam barrel 62 and transmits power of a zoom motor (which is not shown in the present embodiment) to the cam barrel 62 so as to rotate the cam barrel 62. Further, a cam groove (which is not shown in the present embodiment) is provided in an inner surface of the fixed barrel 51, which engages with a cam pin 62a of the cam barrel 62. Accordingly, the cam barrel 62 moves forwards and backwards in the optical axis direction as the cam barrel 62 rotates.

A linearly-moving barrel 61 is guided to straight advance by the fixed barrel 51, and takes a configuration of moving forwards and backwards in synchronization with the movement of the cam barrel 62 in the optical axis direction.

A first unit 10A is configured by including the first lens unit 10 (a first optical member) having a curved shape concave at a side of a light amount adjuster, and the first unit barrel 11 which holds the first lens unit 10. A cam pin 11a is provided in the outer periphery of the first unit barrel 11, which engages with a cam groove (which is not shown in the present embodiment) provided in the inner surface of the cam barrel 62. Further, the first unit barrel 11 engages with the linearly-moving barrel 61 so as to be guided to straight advance. Accordingly, the first unit 10A is capable of moving forwards and backwards in the optical axis direction along with the cam lift of the cam barrel 62. The first unit barrel 11 also includes a lens holder (not shown) surrounding the periphery of the first lens unit 10 in order to hold and fix the first lens unit 10. In the present embodiment, a gap is provided between the first lens unit 10 and the lens holder, whereby an adhesive agent is poured in to the gap, so that the first lens unit 10 may be adhesively fixed to the lens holder after the first lens unit 10 is adjusted to a suitable position. Especially, when the position adjustment of the lenses is not necessary, a resin thermal caulking may be applied instead of the adhesive fixing as in the present embodiment. In either way, the lens holder has a convex shape which is protruded from an R-shape of the first lens unit 10 (that is on an extended line of a curved surface 10R illustrated in FIG. 1).

A second unit 20A is configured by including the second lens unit 20 (a second optical member) having a curved shape convex towards the side of the light amount adjuster, a second unit holder 21 which holds the second lens unit 20, a second unit base 22, an aperture apparatus (an aperture unit or a light amount adjusting apparatus) 23, and the like. A cam pin 22a is provided in the outer periphery of the second unit base 22, which engages with a cam groove (which is not shown in the present embodiment) provided in the inner surface of the cam barrel 62. Further, the second unit base 22 engages with the linearly-moving barrel 61 and is guided to straight advance. Accordingly, the second unit 20A is capable of moving forwards and backwards in the optical axis direction along the cam lift of the cam barrel 62. As illustrated in FIGS. 1 to 3, the first unit 10A (the first lens unit 10 of the first unit 10A) and the second unit 20A (the second lens unit 20 of the second unit 20A) are disposed side by side in the optical axis direction.

FIG. 6 is a detailed perspective view of the second unit 20A of the optical apparatus to which the present embodiment is applied.

The second unit holder 21 holds the second lens unit 20, and includes four magnets (image stabilizers) 21a and four ball receiving portions 21b which are respectively disposed uniformly at angles of approximately 90 degrees. Further, the second unit holder 21 also includes a lens holder 21c surrounding the periphery of the second lens unit 20 in order to fix the second lens unit 20 to the second unit holder 21. In the present embodiment, a gap is provided between the second lens unit 20 and the lens holder 21c, whereby an adhesive agent is poured into the gap so that the second lens unit 20 may be adhesively fixed to the lens holder 21c after the second lens unit 20 is adjusted to a suitable position. Especially, when the position adjustment of the lenses is not necessary, a resin thermal caulking may be applied instead of the adhesive fixing as in the present embodiment. In either way, the lens holder 21c has a convex shape which is protruded from an R-shape of the second lens unit 20 (that is on an extended line of a curved surface 20R illustrated in FIG. 1).

The second unit base 22 includes a cam pin 22a, four coils (image stabilizers) 22b disposed uniformly at angles of approximately 90 degrees so as to face the magnets 21a of the second unit holder 21 respectively, and four ball receiving portions 22c. A ball 24 is disposed in each ball receiving portion 22c, and is held between the ball receiving portion 22c and the ball receiving portion 21b of the second unit holder 21. Further, the second unit holder 21 is pressed with a suitable pressure to the second unit base 22 by an urging element (which is not shown in the present embodiment).

Accordingly, the second unit holder 21 is capable of moving smoothly on a plane perpendicular to the optical axis with respect to the second unit base 22. The second unit holder 21 can move to a desired position at the time of the image stabilizing by electromagnetic power of the magnets 21a and the coils 22b disposed so as to face each other.

The aperture unit (a light amount adjuster) 23 is disposed adjacent to and in front of the second unit 20A (at an object side), and includes a plurality of aperture blades. The aperture unit 23 rotates the plurality of aperture blades to change a diameter of an opening (an aperture) which passes a light beam and adjust the amount of incident light. Further, in the present embodiment, the aperture unit 23 is held by the second unit holder 21. The first lens unit 10 is disposed adjacent to the aperture unit 23 at the object side. In addition, the aperture unit 23 has a curved surface shape convex towards the side of the first lens unit 10 (the side of the first optical member), and a curved surface shape concave towards the side of the second lens unit 20 (the side of the second optical member). That is to say, the aperture unit 23 is configured so as to have a curved surface shape convex towards the side of the optical member having a concave curved surface shape. In the present embodiment, a description is given for a configuration in which the first lens unit 10 has a concave portion at the side of the light amount adjuster and the second lens unit 20 has a convex portion at the side of the light amount adjuster. However, the present invention is not limited to such configuration, and may also take a configuration in which the first lens unit 10 has a convex portion at the side of the light amount adjuster and the second lens unit 20 has a concave portion at the side the light amount adjuster, for example. That is to say, modifications may be made as long as either one of the first lens unit 10 and the second lens unit 20 has a curved shape concave towards the side of the light amount adjuster and the other has a curved shape convex towards the side of the light amount adjuster.

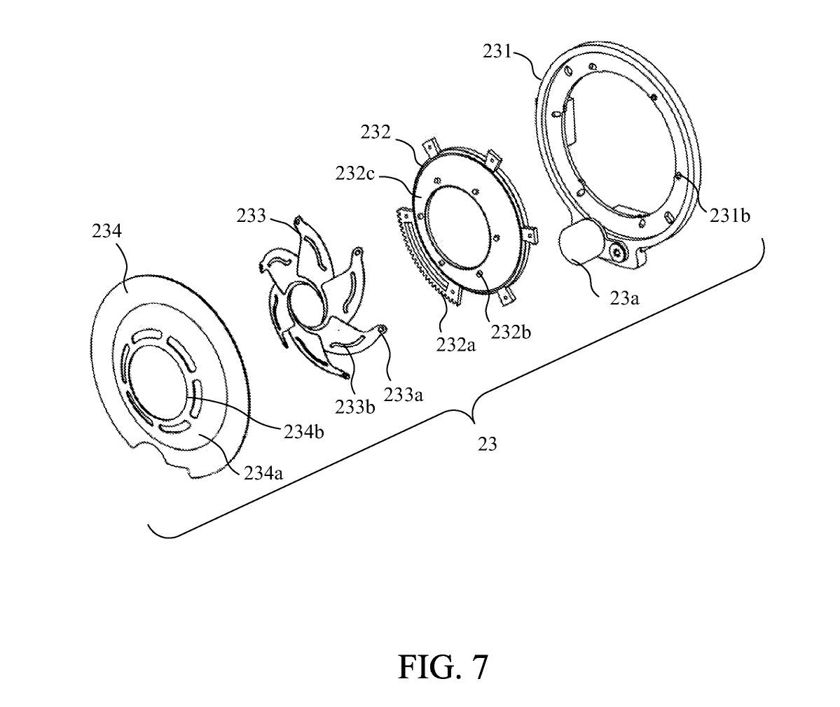

FIG. 7 is a detailed perspective view of the aperture unit 23 of the optical apparatus to which the present embodiment is applied.

The aperture unit 23 is configured by including an aperture bottom plate 231, an aperture driving ring 232, aperture blades 233, and an aperture cover 234.

The aperture bottom plate (a base member) 231 holds a motor (a driving source) 23a which operates the aperture driving ring 232, at the side of the object. Accordingly, the motor 23a is disposed at the side of the object with respect to the aperture bottom plate 231 (which is disposed opposite to the image stabilizer), where the magnets 21a and the coils 22b (the image stabilizers) which perform as the power source of the image stabilizing mechanism are not disposed. Further, as illustrated especially in FIGS. 2 and 3, in a zoom position in which the second unit 20A is arranged most closely to the first unit 10A (or in a retracted state), the motor 23a of the aperture unit 23 is positioned in a space at a side surface of the first lens unit 10. That is to say, in a zoom position in which the second unit 20A is arranged most closely to the first unit 10A (or in a retracted state), the motor 23a is disposed so that at least a part of the motor 23a overlaps the first lens unit 10 in a direction orthogonal to the optical axis. Further, the aperture bottom plate 231 is provided with six dowels 231b, which are fitted into holes 233a that are to be rotation centers of the aperture blades 233.

The aperture driving ring (driving member) 232 includes a gear (a gear portion) 232a which transmits power of the motor 23a, and six dowels 232b. The dowels 232b are fitted into elongate holes 233b of the aperture blades 233. Further, an abutting surface 232c on the front surface of the aperture driving ring 232 (at the side of the object) is a sliding surface with the aperture blades 233. In the present embodiment, the abutting surface 232c is formed to have a curved surface shape.

The aperture blades (the blades) 233 is configured by including six blades, and especially the portion which blocks light rays is formed to have a curved surface shape similar to that of the abutting surface 232c of the aperture driving ring 232.

The aperture cover 234 regulates the position of the aperture blades 233 in the optical axis direction, and is provided on the front surface (at the side of the object) of the aperture blades 233. An abutting surface 234a at a side of an image plane which abuts with the aperture blades 233 is formed to have a curved surface shape similar to that of the aperture blades 233. Further, the aperture cover 234 also includes an aperture portion 234b when the aperture is in an aperture open state.

It is preferable that the curved surfaces of the aperture driving ring 232 (the abutting surface 232c), the aperture blades 233, and the aperture cover 234 (the abutting surface 234a) have approximately the same curved surface (radius of curvature).

In the aperture unit 23 of the above described configuration, the aperture blades 233 move along the trajectory of the elongate holes 233b when the aperture driving ring 232 rotates by the driving of the motor 23a, whereby the diameter of the aperture formed by the six aperture blades 233 changes. At this time, the six aperture blades 233 move while rotating along the abutting surface (curved surface) with the aperture cover 234 and/or the aperture driving ring 232.

The abutting surface 232c of the aperture driving ring 232 and the abutting surface 234a of the aperture cover 234 have curved surface shape as described above, and the aperture blades 233 also have a curved surface shape similar to these shape. The radius of curvature (a first radius of curvature) of the curved surfaces (R surface) is set in a range between the radius of curvature (a second radius of curvature) of the curved surface of the first lens unit 10 and the radius of curvature (a third radius of curvature) of the curved surface of the second lens unit 20. That is to say, the radius of curvature of the curved surfaces (23R in FIG. 1) is set to be smaller than the radius of curvature of the curved surface 10R (of the concave portion) of the first lens unit 10 and to be larger than the radius of curvature of the curved surface 20R (of the convex portion) of the second lens unit 20. In this case, the radius of curvature of the curved surface of the second lens unit 20 is smaller than the radius of curvature of the curved surface of the first lens unit 10. In the case of the above described configuration where the first lens unit 10 has a convex portion at the side of the light amount adjuster and the second lens unit 20 has a concave portion at the side of the light amount adjuster, the magnitude relationship of the radii of curvatures is reversed. That is to say, the radius of curvature of 23R in FIG. 1 is set to be smaller than the radius of curvature of the curved surface 20R (of the concave portion) of the second lens unit 20 and to be larger than the radius of curvature of the curved surface 10R (of the convex portion) of the first lens unit 10. In this case, the radius of curvature of the curved surface of the first lens unit 10 is smaller than the radius of curvature of the curved surface of the second lens unit 20.

Thus, the aperture unit 23 to which the present embodiment is applied is configured so that the six aperture blades 233 rotate along the curved surface of the aperture cover 234 and/or the aperture driving ring 232. Accordingly, even in a telephoto state at the time of taking an image where a part of the second lens unit 20 is inserted into the first lens unit 10, for example, the aperture blades 233 of the aperture unit 23 may be driven from an open state to a small aperture state, without interfering the first lens unit 10 and the second lens unit 20.

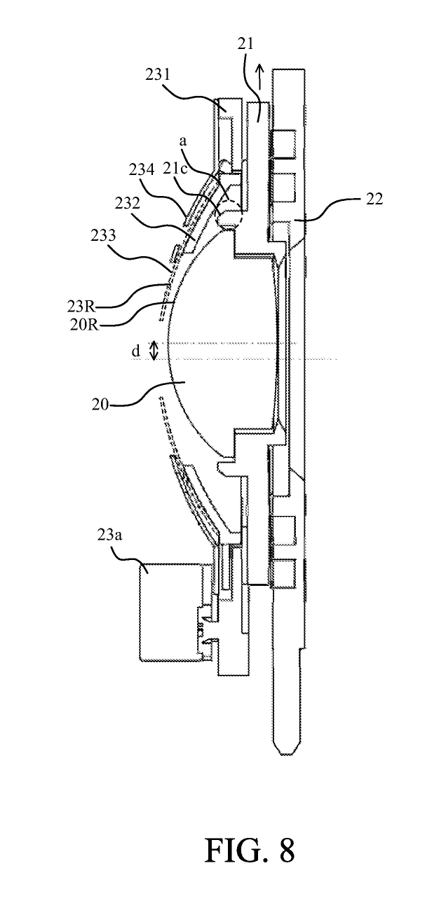

FIG. 8 is a cross-sectional view of the second unit 20A of the optical apparatus to which the present embodiment is applied, which specifically shows a state where the second unit holder 21 is moved by the image stabilizing mechanism to a direction indicated by an arrow in the drawing.

As illustrated in FIG. 8, in the present embodiment, the radius of curvature of the curved surface 23R formed by the aperture blades 233 is set to be larger than the radius of curvature of the curved surface 20R of the second lens unit 20. Accordingly, there is a space between the aperture driving ring 232 and the second lens unit 20 (as indicated by “a” in FIG. 8). The lens holder 21c which is protruded from the curved surface 20R of the second lens unit 20 to the side of the light amount adjuster can be disposed in this space. Further, even in a state where the second unit holder 21 is moved in a direction orthogonal to the optical axis by driving the image stabilizing mechanism as illustrated in FIG. 8, the lens holder 21c protruding from the curved surface 20R does not interfere at the first time. Accordingly, a larger amount of correcting an image blur (image stabilizing amount) can be set in a limited space. In the present embodiment, a distance between the lens holder 21c and the aperture unit 23 (the aperture driving ring 232) in a direction orthogonal to the optical axis before driving the image stabilizing mechanism is longer than the maximum driving distance d of the second lens unit 20 at the time of the image stabilizing. In order to achieve the configuration, a difference between the radius of curvature of the curved surface 23R of the aperture blades 233 and the radius of curvature of the curved surface 20R of the second lens unit 20 is provided, and thus the lens holder 21c and the aperture unit 23 do not come into contact with each other even when the movement of the second lens unit 20 is not limited during the image stabilizing. As a result, sufficient image stabilizing performance can be obtained at the time of the image stabilizing.

According to the present embodiment, even when the distance between the first lens unit 10 and the blade member or the distance between the blade member and the second lens unit 20 in the optical axis direction is decreased as much as possible, the interference of each of the members can be prevented, and the reduction of the thickness in the optical axis direction can be achieved while securing the sufficient image stabilizing performance.

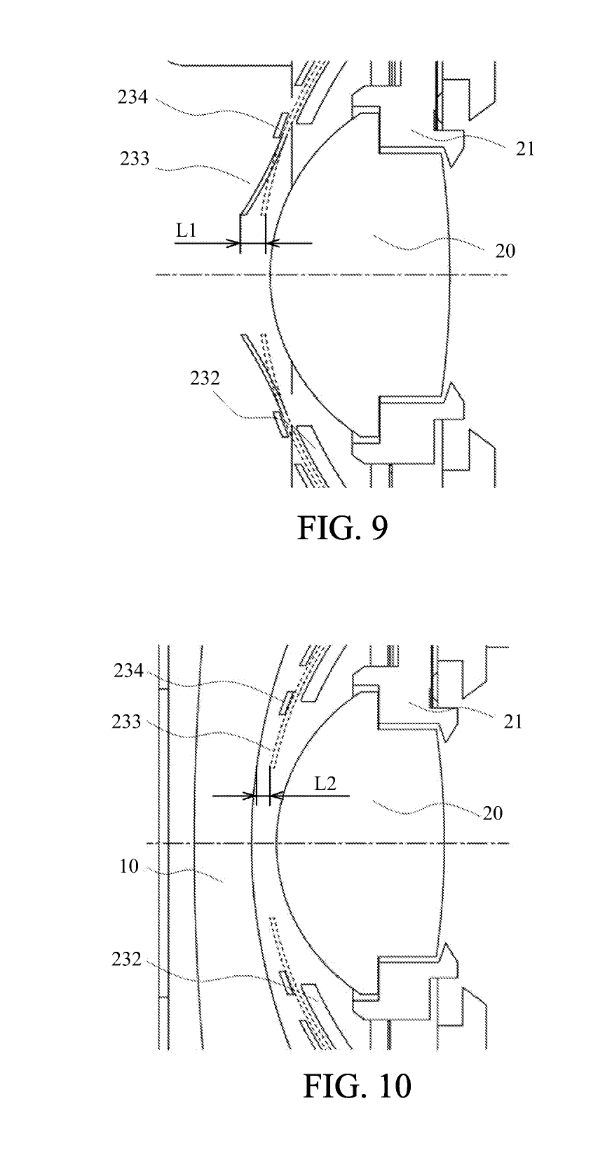

Next, the relationship of a bending amount L1 of the aperture blades 233 and the distance L2 between the first unit 10A and the aperture blades 233 is described. FIG. 9 is an expanded cross-sectional view of part A illustrated in FIG. 1, and FIG. 10 is an expanded cross-sectional view of part B illustrated in FIG. 2.

As illustrated in FIG. 1, when the lens barrel is in a wide-angle state, the distance L2 between the first unit 10A and the aperture blades 233 is sufficiently large. Accordingly, even when the aperture blades 233 are bent by the distance L1 at the side of the object (the side of the first lens unit 10) in the small aperture state as illustrated in FIG. 9, the aperture blades 233 do not interfere with the first unit 10A since a distance between the first unit 10A and the aperture blades 233 is not less than the distance L1.

When a zoom operation is performed from the wide-angle state, the distance L2 between the first unit 10A and the aperture blades 233 is gradually decreased, and the first unit 10A and the aperture blades 233 is to be the closest when the lens barrel is in a telephoto state as illustrated in FIG. 10 among image-taking states.

In this case, as the zoom operation changes from the wide-angle state to the telephoto state, the F number is increased, and is darkened, whereby the aperture amount of the aperture blades 233 is reduced. Accordingly, the relationship of L2>L1 is always maintained during the wide-angle state to the telephoto state, and the first unit 10A and the aperture blades 233 do not interfere with each other in the entire image-taking state.

Further, the second unit 20A constituting the image stabilizing mechanism is disposed in a direction opposite to a direction in which the aperture blades 233 are bent, and therefore the second unit 20A does not interfere with the aperture blades 233 and the drive of the image stabilizing lens (the second lens unit 20) is not prevented.

As described above, in the optical apparatus to which the present embodiment is applied, and the image pickup apparatus including the optical apparatus, the reduction of the thickness in the optical axis direction can be achieved and the image stabilizing amount can also be increased by the configuration described above.

Further, in the present embodiment, a configuration in which the moving portion holds the balls, and the moving portion is driven by an electromagnetic power of the magnets 21a and the coils 22b is adopted. However, the positional relationship of the magnets 21a and the coils 22b may be reversed. As a modification of the present embodiment, a configuration in which two guide bars are used, and two axes are respectively movable, which are driven by two stepping motors, may also be applicable.

Further, in the present embodiment, although the lens holder 21c protruded from the R-shape (the curved surface 20R in the drawings) of the second lens unit 20 is described as the shape for lens adhesion, another method of holding the lens may also be applied. For example, the lens holder 21c may be formed into a fingernail shape for thermal welding and caulking, or a press-fitting-in portion which holds the lens by pressing the lens therein.

### Embodiment 2

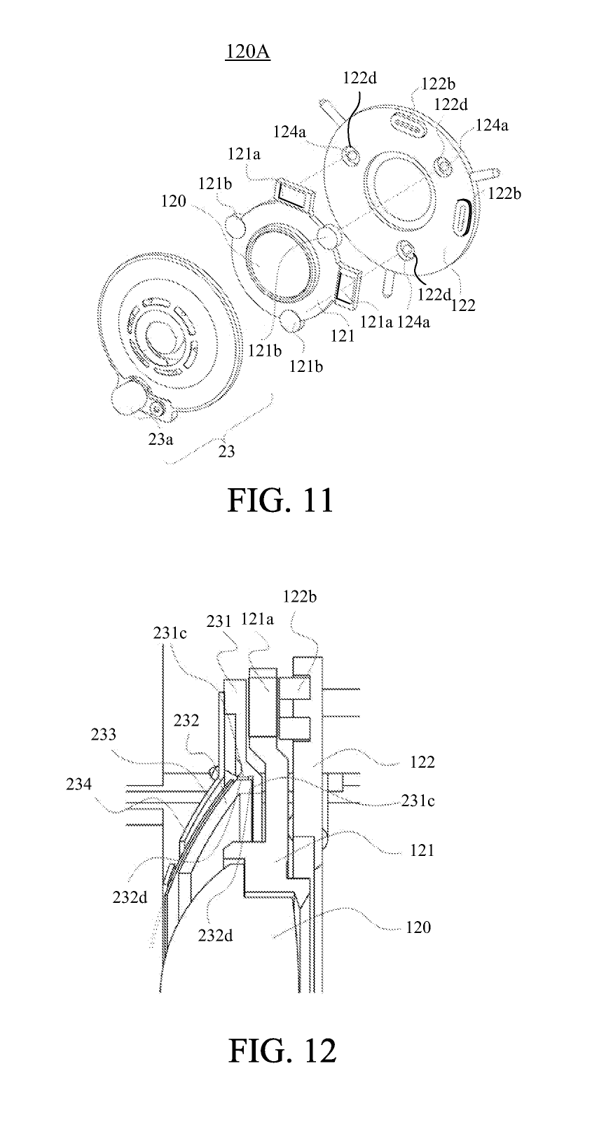

FIG. 11 is a detailed perspective view of a second unit 120A which is a modification of the second unit 20A according to Embodiment 1 of the present invention, which is a front perspective view in which the second unit 120A is viewed from the front (at the side of the object).

As illustrated in FIG. 11, the second unit holder 121 holds the second lens unit 120, and includes two magnets (image stabilizers) 121a disposed at an angle of approximately 90 degrees different from each other, and three ball receiving portions 121b.

The second unit base 122 is disposed so as to face the pair of the magnets 121a, and includes a pair of coils (image stabilizers) 122b disposed uniformly at an angle of approximately 90 degrees, and three concave ball receiving portions 122d.

The aperture unit 23 has the similar configuration as that of Embodiment 1 illustrated in FIG. 7, and the description thereof is omitted.

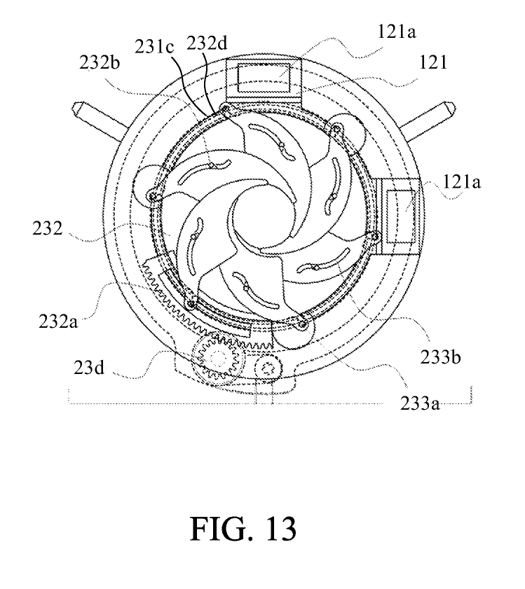

Next, the positional relationship between the aperture unit 23 and the second unit holder 121 according to the present invention is described with reference to FIGS. 12 and 13.

FIG. 12 is a detailed enlarged cross-sectional view of the positional relationship between the aperture unit 23 of the second unit 120A and the second unit holder 121 of the optical apparatus to which the embodiment of the present invention is applied.

FIG. 13 is a front transparent view in which the second unit 120A of the optical apparatus to which the embodiment of the present invention is applied is viewed from a front side.

As illustrated in FIG. 13, the gear 23d attached to an output shaft of the motor 23a and the gear 232a of the aperture driving ring 232 are disposed on positions opposite to the two magnets 121a of the second unit holder 121 with respect to the optical axis of the second lens unit 120 when viewed from the front (at the side of the object). The gear 23d and the gear 232a of the aperture driving ring 232 are also disposed on the side opposite to the coils 122b of the second unit base 122 disposed so as to face the magnets 121a with respect to the optical axis.

Further, as illustrated in FIG. 12, the sliding portions 231c and 232d of the aperture bottom plate 231 and the aperture driving ring 232 are disposed so as not to overlap with the two magnets 121a of the second unit holder 121 when viewed from the front (at the object side). Specifically, the sliding portions 231c and 232d are disposed at the side of the optical axis (at a position closer to the optical axis) relative to the magnet 121a as illustrated in FIG. 13.

Accordingly, even when the sliding portions 231c and 232d of the aperture bottom plate 231 and the aperture driving ring 232 are disposed so as to overlap with and be inserted into the magnets 121a of the second unit holder 121 at a plane perpendicular to the optical axis as illustrated in FIG. 12, the aperture unit 23 and the second unit holder 121 do not interfere with each other. That is to say, at least a part of the sliding portions 231c and 232d of the aperture unit 23 and at least a part of the magnets 121a of the second unit holder 121 are disposed so as to overlap with each other in a direction orthogonal to the optical axis. In this configuration, a clearance of the aperture unit 23 and the second unit holder 121 can be minimized.

Here, the relationship between the second unit holder 121 and the second unit base 122 constituting the image stabilizing mechanism is described. The magnets 121a of the second unit holder 121 face the coils 122b of the second unit base 122. Further, the ball receiving portions 121b of the second unit holder 121 face the three balls 124a placed on the ball receiving portions 122d of the second unit base 122, and thus the balls 124a are held in a sandwiched manner.

Further, the second unit holder 121 is pressed to the second unit base 122 with a suitable pressure by an urging element (which is not shown in the present embodiment).

Accordingly, the second unit holder 121 can move smoothly in a plane perpendicular to the optical axis direction with respect to the second unit base 122. The second unit holder 121 may be moved to a desired position at the time of the image stabilizing, by electromagnetic power of the magnets 121a and the coils 122b which are opposed to each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the present invention, the reduction of the thickness of an optical apparatus and an image pickup apparatus including the optical apparatus in the optical axis direction can be achieved.

The present invention is suitably applicable to a camera system such as a compact digital camera, a single-lens reflex camera, a video camera. Further, the present invention is also applicable to electronic equipment which mounts the optical apparatus such as a cell phone, a smart phone, a portable game device.

This application claims the benefit of Japanese Patent Application No. 2012-221998, filed on Oct. 4, 2012, which is hereby incorporated by reference herein in its entirety.

What is claimed is:

1. An optical apparatus comprising:
a first optical member on which a concave curved surface is formed;
a second optical member on which a convex curved surface is formed; and
a light amount adjuster which includes a plurality of blade members each having a convex curved shape portion, configured to change a size of an aperture to pass a light beam by a rotation of the blade members,
wherein the first optical member and the second optical member are disposed side by side in an optical axis direction so that the concave curved surface of the first optical member and the convex curved surface of the second optical member face each other,
wherein the light amount adjuster is disposed between the first optical member and the second optical member, and
wherein a radius of curvature of the convex curved shape portion of the blade member is smaller than a radius of curvature of the concave curved surface of the first optical member and is larger than a radius of curvature of the convex curved surface of the second optical member.

2. The optical apparatus according to claim 1, further comprising an image stabilizer configured to drive the second optical member in a direction orthogonal to an optical axis so as to perform an image stabilization.

3. The optical apparatus according to claim 2, further comprising a holder configured to hold the second optical member;
wherein a distance between the holder and the light amount adjuster in the direction orthogonal to the optical axis before driving the image stabilizer is larger than a maximum driving distance of the second optical member when performing the image stabilization.

4. The optical apparatus according to claim 2,
wherein the light amount adjuster includes:
a base member which holds a power source of the light amount adjuster; and
a driving member having a gear portion which transmits power from the power source, and
wherein at least parts of sliding portions of the base member and the driving member overlap with the image stabilizer in a direction orthogonal to the optical axis.

5. The optical apparatus according to claim 4, wherein the power source is disposed at a side opposite to the image stabilizer with respect to the optical axis.

6. The optical apparatus according to claim 4, wherein the power source is disposed at a side opposite to the image stabilizer with respect to the base member.

7. The optical apparatus according to claim 4, wherein at least a part of the power source overlaps with one of the optical members in the direction orthogonal to the optical axis, in a state where the first optical member and the second optical member are closest to each other.

8. An image pickup apparatus comprising:
a first optical member on which a concave curved surface is formed;
a second optical member on which a convex curved surface is formed; and
a light amount adjuster which includes a plurality of blade members each having a convex curved shape portion, configured to change a size of an aperture to pass a light beam by a rotation of the blade members,
wherein the light amount adjuster is disposed between the first optical member and the second optical member, and
wherein a radius of curvature of the convex curved shape portion of the blade member is smaller than a radius of curvature of the concave curved surface of the first optical member and is larger than a radius of curvature of the convex curved surface of the second optical member.
